(19) United States
(12) Patent Application Publication
(10) Pub. No.: US 2009/0139798 A1
(43) Pub. Date: Jun. 4, 2009

(54) Position indicating steps

(76) Inventor: David J. Bernard, Ocean Ridge, FL (US)

Correspondence Address: William M. Hobby, III, #375, 157 E. New England Avenue, Winter Park, FL, 32789, US

(21) Appl. No.: 11/998,723

(22) Filed: Dec. 3, 2007

(51) Int. Cl. E06C 7/00

(52) U.S. Cl. 182/18

(57) ABSTRACT

An audible position indicating system for stairs or ladders includes a switch located on each step which is activated by a person's foot to produce a signal for the step. A sound recording means has one or more sound recording devices having a recorded message thereon and operatively connected to an audio speaker positioned adjacent the plurality of steps. A person is audibly advised of his position on the ladder or stairs as he ascends or descends the ladder or stairs.

### BACKGROUND OF THE INVENTION

The present invention relates to an audible position indicating system for stairs or ladders to audibly indicate to a person using the steps of the stairs or ladder of his position on the ladder or stairs as he ascends or descends the ladder or stairs.

A ladder or set of stairs both utilize steps and are used in business and everyday life to provide access to and from various heights so that ladders and stairs become a part of everyday life. Ladders and stairs are provided to allow access to various elevations or heights and are used in homes and businesses, warehouses, retail stores, public places and private locations. At times, people use these devices without a clear view in front or behind them. They may have their view obstructed by packages, people or other obstacles. In these situations, the risk of an accident is increased by falling or missing a step or a rung of a ladder, resulting in injury. The present invention is an aid to the visually impaired and all users providing audible information to assist them in the use of a set of stairs or a ladder. Railings and written warnings are currently employed to assist the safety of the ladder or stair user but it is still desirable in certain situations to give a person a better feel for his position on the steps or ladder.

In the past, there have been various techniques for improving the safety on a ladder. In U.S. Pat. No. 3,298,012 to Weller a mercury switch is use to turn on a signal or alarm when unauthorized access to a ladder is made. In U.S. Pat. No. 5,547,412 an electronic message is played when a child steps on a child oriented single step device. This is an educational or entertainment device. U.S. Pat. No. 5,740,881, issued to Lensak, provides a method of sounding an alarm when an upright ladder is placed in an unsafe angle relative to the ground. In U.S. Pat. No. 5,954,154, the bottom step of a ladder has a switch that switches on a light. In U.S. Pat. No. 4,311,208 to Macrorie et al., a warning light is provided to use on ladders to indicate the presence of someone on the ladder. A switch is activated by a person's foot placed on the lower rung of the ladder to switch on a flashing light. In the U.S. Pat. No. 6,966,403 to Chandra a smart ladder has a tip warning system. A tip warning system has an audio alarm and a visual alarm located on one end of a ladder to indicate imbalance conditions in order to warn a user of an imbalance condition.

The present invention relates to steps, stairs and ladders and audibly advises a person which step or position he is located on the steps.

### SUMMARY OF THE INVENTION

An audible position indicating system for stairs or ladders having a plurality of stair or ladder steps includes a switch located on each step which is activated by a person's foot to produce a signal for the step. A sound recording means has one or more sound recording devices having a recorded message thereon and operatively connected to an audio speaker positioned adjacent the plurality of steps. A person is audibly advised of his position in any language on the ladder or stairs as he ascends or descends the ladder or stairs. The audio recording means may have a plurality of audio recording devices, each of which is connected to a switch on one step and to at least one audio speaker whereby each switch activates one audio recording device to audibly indicate the step having the switch. A plurality of audio speakers can be utilized, one for each step, or one speaker can be connected to all of the audio recording devices. An audio recording device can be a microchip and the switch may be a pressure, capacitance or inductance actuated switch or other type switch either built into a step or can be a light actuated switch as desired.

### BRIEF DESCRIPTION OF THE DRAWINGS

Other objects, features, and advantages of the present invention will be apparent from the written description and the drawings in which:

FIG. 1 is a perspective view of stairs having the present invention incorporated therein;

FIG. 2 is a side elevation of a ladder having an audible position indicating system therein;

FIG. 3 is a perspective view of a talking step in accordance with the present invention;

FIG. 4 is a perspective view of a talking step built into a single layer system;

FIG. 5 is a schematic of the sensing system for use in FIGS. 1 through 4;

FIG. 6 is a perspective view of an alternate embodiment of the position indicating stairs of the present invention; and

FIG. 7 is an alternate schematic diagram for the position indicating stairs of the present invention.

### DETAILED DESCRIPTION OF THE PREFERRED EMBODIMENT

The present invention is a step of a set of stairs or a ladder which audibly provides a user with the location of the step on the ladder or stairway. The step can be located on a ladder rungs or treads, or it can be steps on a stairway. The steps can be built to incorporate the invention or it can have the invention attached to an existing step using adhesives or mounting hardware at a later date.

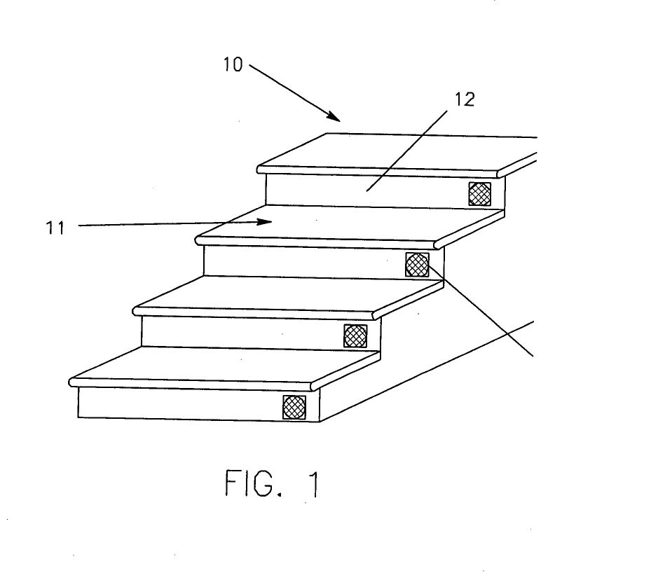

Referring to the drawing of FIG. 1, a set of stairs or stairway 10 has a plurality of steps 11, each pair of steps being separated by a riser 12. Each riser has mounted therein an audible speaker 13.

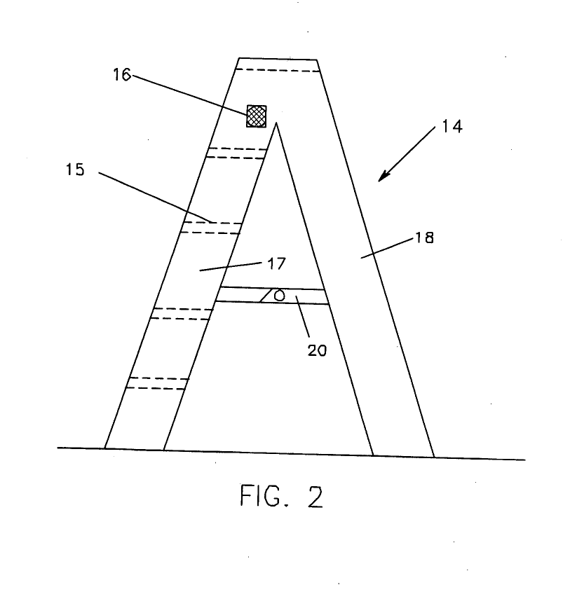

FIG. 2 illustrates a ladder 14 having a series of rungs or steps 15 and having an audible speaker 16 mounted in the side thereof. The step ladder 14 includes side rails 17 and support side rails 18. Side rails 17 and 18 are connected with a supporting brace 20.

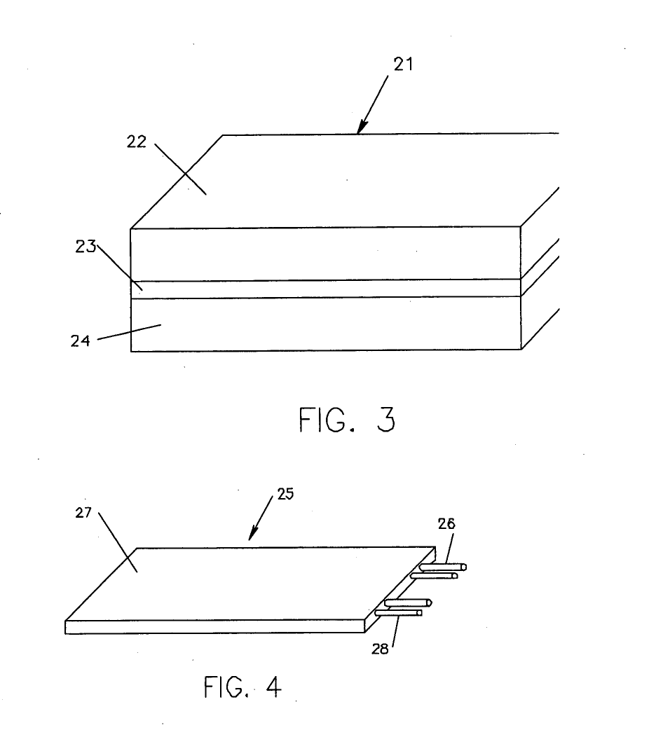

Each step 11 or 15 may have a step made in accordance with the step 21 of FIG. 3. Step 21 has a built in sensor or switch that can be fashioned out of any material desired and may have a top surface 22 which can also be covered with carpets, rugs or non-slip surfaces as desired. The top surface can be wood, metal, composites or any desired material and has attached therebelow a sensor 23. Sensor 23 can be a pressure sensor or a capacitance or inductance sensor or other type sensor and generates an electrical signal whenever a predetermined pressure is applied thereto. For instance, a piezoelectric pressure material can be utilized for the sensing layer 23. Once the sensor has sensed a load on the surface 22, it produces an electrical output which is used to activate a recording device to produce a recorded message in speaker 13 for the particular step that the person is standing on. The audible message can indicate the position of a person relative to multiple steps in a stairway or a ladder. It can also indicate a warning, such as the top step, or any other area where a special warning is desirable. Bottom 24 of the step 21 can be made of the same material as the top 22.

Referring more specifically to FIG. 4, a step 25 can be made as a stand alone item having a sensor and, if desired, the power supply, message device and speaker built thereinto. The step 25 has a plurality of connectors 26 extending therefrom beneath the surface 27 of the step 25. Connectors 26 can be connected to a power source for powering the sensors and anything else incorporated into the step. The power source typically would be a DC battery or building electric source. The step 25 also has connectors 28 for connecting to an external speaker or an external recording device and speaker.

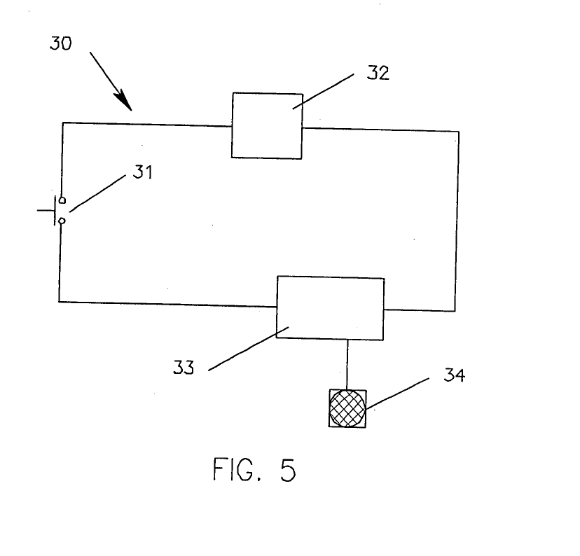

In the diagram of FIG. 5, a circuit 30 has a switch 31 which is connected to a power source 32 which typically would be a battery pack, or in the case of a stairway, an AC commercial power. A power supply is used to reduce the household voltage and for converting the AC voltage to a DC voltage. A power source 32 is connected through the switch 31 to a recording device 33. The recording device 33 can be a programmed microchip which produces a recorded message for a particular step in the system or, can of course be a radio frequency transmitter which can transmit to a remote receiver, such as an intercom, speaker or other device, which in turn is connected to the speaker 34. The recording device and other components of the system would typically be in a waterproof housing or encapsulated for outdoor use.

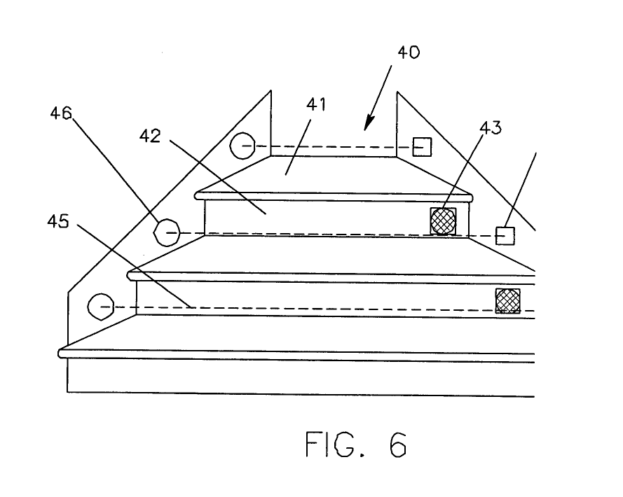

Turning now to FIG. 6, a set of stairs 40 having steps 41 and risers 42 can have speakers 43 incorporated into the risers. In this case, an optical switch can be utilized which can have a light emitting diode or laser or other light source 44 directing a beam 45 to a reflector 46. The switch is activated by breaking the lightbeam 45 by a person stepping or standing on the step 41. In lieu of an LED, an ultrasonic sensor can also be utilized. The light source 44 directs a beam 45 at the reflector 46 which reflects the light back to a receiver which generates a signal when the beam is broken to activate a recording device for producing a signal at the speaker 34.

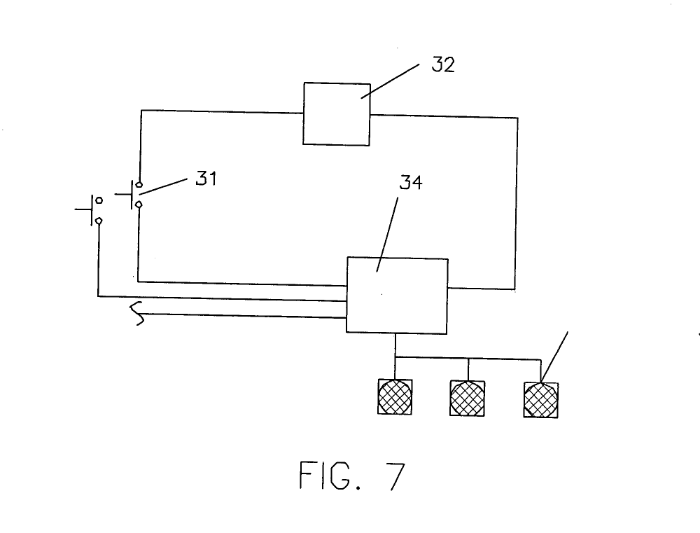

FIG. 7 illustrates a second electrical circuit having the switch 31 connected to the power source 32 and to a recording device 34. Recording device 34 can receive signals from a plurality of switches 31 and determine which step switch 31 is activated to play the audio output for that step on speaker 35.

It should be clear at this point that a talking step or steps audibly indicate the position of a user on the stairs or on a ladder. However, it should also be clear that the present invention is not to be limited to the forms shown which are to be considered illustrative rather than restrictive.

I claim:

1. An audible position indicating system for stairs and ladders comprising: a plurality of stair or ladder steps;
a switch located on each step of said plurality of stair or ladder steps, each said switch being activated by a person's foot to produce a signal indicative of which of said plurality steps has been stepped on;
at least one audio speaker positioned adjacent said plurality of steps;
sound recording means having a recorded message thereon operatively connected to at least one said switch, said sound recording means being operatively connected to at least one said audio speaker to audible announce which step a person has stepped upon;
whereby a person is audible advised of his position on a ladder or stairs as he ascends or descends the ladder or stairs.

2. An audible position indicating system for stairs and ladders in accordance with claim 1 in which each said audio recording means includes a plurality of audio recording devices, each said audio recording device being connected to one said switch and to at least one said audio speaker whereby each said switch activates one said audio recording device to audibly indicate the step having the switch activated.

3. An audible position indicating system for stairs and ladders in accordance with claim 2 having a plurality of said audio speakers, each said audio speaker being positioned on one said step and connected to one audio recording device to announce the position of the step when said switch on that step is activated.

4. An audible position indicating system for stairs and ladders in accordance with claim 3 in which each said audio recording device is an audio microchip.

5. An audible position, indicating system for stairs and ladders in accordance with claim 1 in which each said switch is a light beam actuated switch.

6. An audible position indicating system for stairs and ladders in accordance with claim 1 in which each said switch is an ultrasonic actuated switch.

7. An audible position indicating system for stairs and ladders in accordance with claim 1 in which each said switch is a pressure sensitive switch located on each step and activated by the pressure of a person standing on said step.

8. An audible position indicating system for stairs and ladders in accordance with claim 1 in which each said step has said switch built therein.

9. An audible position indicating system for stairs and ladders in accordance with claim 1 in which each switch located on each step is connected to one audio recording means audio recording device and to at least one speaker to audible indicate the step of the activated switch.
